(19) United States
(12) Patent Application Publication
(10) Pub. No.: US 2008/0144839 A1
(43) Pub. Date: Jun. 19, 2008

(54) Characteristics Measurement Device and Characteristics Measurement Program

(75) Inventors: Hajime Yoshino, Saitama (JP); Akira Hattori, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 11/885,178

(22) PCT Filed: Feb. 28, 2006
(86) PCT No.: PCT/JP2006/003761

§ 371 Date: Oct. 31, 2007

(30) Foreign Application Priority Data
Feb. 28, 2005 (JP) 2005-054526

(51) Int. Cl. H04R 29/00

(52) U.S. Cl. 381/56

(57) ABSTRACT

A characteristics measurement device is applicable to various kinds of measurement devices for measuring characteristics subjected to a measurement in a certain environment. The characteristics measurement device measures a noise level in the environment, and determines the noise state based on the obtained noise level. Then, the characteristics measurement device determines the number of times of measurement of the characteristics based on the noise state, and executes synchronized addition of the characteristics obtained by the plural measurements to output the characteristics. Thus, when the noise state in the environment of the measurement execution is preferable, the measurement is completed in the smallest number of times of measurement. Additionally, when the noise state of the environment is not preferable, the plural measurements are executed in order to obtain the desired noise state (e.g., S/N), and the results are synchronized and added. Since the influence of the noise is reduced by repeating the synchronized addition, the measurement result with high accuracy can be obtained. In the environment of the measurement execution, an unexpected noise other than an ordinary noise may occur. If the unexpected noise occurs, measurement accuracy largely becomes low. Then, when a correlation of the plural measurement results is low, it is assumed that the unexpected noise occurs. By increasing the number of times of measurement, the influence of the unexpected noise can be removed.

### TECHNICAL FIELD

The present invention relates to a characteristics measurement, i.e., measuring of characteristics subject to a measurement in a certain environment.

### BACKGROUND TECHNIQUE

In a specific environment, various kinds of characteristics subjected to measurements are measured. As an example of the characteristics measurement, there are a system for measuring sound characteristics in a certain sound space and a system for measuring transmission characteristics of a light and an electric wave in a certain environment.

For example, in an audio system including plural speakers and providing a high-grade sound space, it is necessary to automatically create an appropriate sound space with the presence. Namely, even though a listener operates the audio system in order to obtain the appropriate sound space, it is extremely difficult for him or her to appropriately control phase characteristics, frequency characteristics and a sound pressure level of sounds reproduced by the plural speakers. Therefore, it becomes necessary to automatically correct sound field characteristics in the audio system.

Conventionally, as an automatic sound field correcting system of this kind, there is known a system disclosed in Patent Reference-1. In this system, a test signal outputted from a speaker is collected, and frequency characteristics thereof are analyzed, for each signal transmission path corresponding to plural channels. Then, a coefficient of an equalizer arranged in the signal transmission path is set. Thereby, the frequency characteristics in each signal transmission path are desirably corrected.

Additionally, a signal delay time of each signal transmission path corresponding to the plural channels is measured, and the signal delay characteristics of each transmission path are adjusted. In the normal signal delay time measurement, a processor in an automatic sound field correcting system outputs a measurement pulse, and at the same time, the processor starts capturing microphone input. Then, the time until the level of the microphone input becomes larger than a predetermined threshold for the first time is determined as the signal delay time.

As for the above-mentioned characteristics measurement, there is known such a technique that the same measurement is executed for plural times and measurement results are obtained. Namely, the measurement is executed for the plural times, because of a cause existing in an environment in which the measurement is executed and causing a variation of the measurement result, i.e., for the purpose of removing an influence of a noise in the measurement environment and improving the measurement accuracy. In this case, it is general that the number of times of measurement is a fixed number predetermined based on the noise state in the environment.

Patent Reference-1: Japanese Patent Application Laid-open under No. 2002-330499

However, in the case of fixing the number of times of measurement, the number of times of measurement has to be determined by assuming a case of the worst noise state (e.g., a case of a bad S/N state) in the environment and considering completion of the measurements in an actual time period. Hence, even when the actual environment is better than the worst noise state, the measurement is executed for the number of times of measurement, which is determined in correspondence with the worst noise state. As a result, it problematically takes longer time than needed to execute the measurement. Meanwhile, in such a case that the noise state better than the worst noise state is assumed and the smaller number of times of measurement is set in order to shorten the measurement time, if the noise state in the actual environment is worse than assumed, it problematically becomes impossible to obtain the accurate measurement result.

### DISCLOSURE OF INVENTION

### Problem to be Solved by the Invention

The present invention has been achieved in order to solve the above problems. It is an object of this invention to provide a characteristics measurement device and a program capable of obtaining a measurement result with high accuracy in the minimum number of times of measurement, in accordance with a noise state in an environment in which the measurement is executed.

### Means for Solving the Problem

According to one aspect of the present invention, there is provided a characteristics measurement device which measures characteristics subjected to a measurement, including: a noise level measurement unit which measures a noise level in an environment subjected to the measurement; a noise state determination unit which determines a noise state in the environment, based on the noise level; a measurement number determination unit which determines a number of times of measurement, based on the noise state; and a characteristics measurement unit which measures the characteristics subjected to the measurement for the number of times of measurement, and executes synchronized addition of measurement results to output the measurement results.

The above characteristics measurement device is applicable to various kinds of measurement devices for measuring the characteristics subjected to the measurement in the certain environment. In addition, the above characteristics measurement device measures the noise level in the environment, and determines the noise state based on the obtained noise level. Then, the characteristics measurement device determines the number of times of measurement of the characteristics based on the noise state, and executes synchronized addition of the characteristics obtained by the plural measurements to output the characteristics. Thus, in such a case that the noise state in the environment in which the measurement is executed is preferable, the measurement is completed in the minimum number of times of measurement. Additionally, in such a case that the noise state in the environment is not preferable, the plural measurements are executed in order to obtain a desired noise state (e.g., S/N), and the results are synchronized and added. Since the synchronized addition is repeated and the influence of the noise is reduced, the measurement results with high accuracy can be obtained.

In a manner, the above characteristics measurement device may further include a signal level measurement unit which measures the signal level subjected to the measurement in the environment, and the noise state determination unit may determine the noise state, based on the signal level and the noise level. In this manner, since the noise state (e.g., S/N) is determined with using the signal level subjected to the measurement in the environment in which the measurement is executed, it becomes possible to determine the accurate noise state in the environment.

In a preferred example, the noise level measurement unit may measure the noise level prior to the measurement of the characteristics subjected to the measurement. The noise level measurement unit may measure the noise level during the measurement of the characteristics subjected to the measurement. Moreover, the noise level measurement unit may measure the noise level prior to the measurement of the characteristics subjected to the measurement, and may measure the noise level during the measurement of the characteristics subjected to the measurement. The noise state determination unit may determine the noise state, based on a largest noise level which is measured.

In another manner of the above characteristics measurement device, the measurement number determination unit may increase the number of times of measurement, as the noise state becomes insufficient. Thus, by the effect of the synchronized addition, the influence of the noise in the measurement result can be reduced, and the measurement result with the high accuracy can be obtained.

In still another manner, the above characteristics measurement device may further include a correlation determination unit which determines a correlation of the plural measurement results, and the measurement number determination unit may increase the number of times of measurement, when the correlation is smaller than a predetermined reference. In the environment in which the measurement is executed, an unexpected noise other than an ordinary noise may occur. If the unexpected noise occurs, the measurement accuracy extremely becomes low. Therefore, when the correlation of the plural measurement results is low, it is assumed that the unexpected noise occurs. By increasing the number of times of measurement, the influence of the unexpected noise can be removed.

According to another aspect of the present invention, there is provided a characteristics measurement device which measures characteristics subjected to a measurement, including: a characteristics measurement unit which measures the characteristics subjected to the measurement for a number of plural measurements and executes synchronized addition of measurement results to output the measurement results; a correlation determination unit which determines a correlation of the plural measurement results; and a measurement number determination unit which determines the number of times of measurement, based on a determination result of the correlation.

The above characteristics measurement device is applicable to various kinds of measurement devices which measures the characteristics subjected to the measurement in the environment. The above characteristics measurement device measures the characteristics subjected to the measurement in the number of plural measurements, and executes the synchronized addition of the measurement results to output the measurement results. Then, the characteristics measurement device measures the noise level in the environment, and determines the noise state based on the obtained noise level. In the environment in which the measurement is executed, the unexpected noise other than the ordinary noise may occur. If the unexpected noise occurs, the measurement accuracy extremely becomes low. Therefore, when the correlation of the plural measurement results is low, it is assumed that the unexpected noise occurs. By increasing the number of times of measurement, the influence of the unexpected noise can be removed.

In a preferred example of the above characteristics measurement device, the characteristics subjected to the measurement may be any one of a sound characteristic, a light transmission characteristic, a wave transmission characteristic and an electric circuit characteristic. In addition, the sound characteristics may be any one of a signal delay characteristic, a sound pressure level characteristic, a frequency characteristic and a speaker characteristic in a sound space.

According to still another aspect of the present invention, there is provided a characteristics measurement program executed on a computer and measuring characteristics subjected to a measurement, making the computer function as: a noise level measurement unit which measures a noise level in an environment subjected to a measurement; a noise state determination unit which determines a noise state in the environment, based on the noise level; a measurement number determination unit which determines a number of times of measurement, based on the noise state; and a characteristics measurement unit which measures the characteristics subjected to the measurement for the number of times of measurement, and executes synchronized addition of measurement results to output the measurement results. By executing the program on the computer, the above characteristics measurement device can be realized.

According to still another aspect of the present invention, there is provided a characteristics measurement program executed on a computer and measuring characteristics subjected to a measurement, making the computer function as: a characteristics measurement unit which measures characteristics subjected to the measurement for a number of plural measurements, and executes synchronized addition of measurement results to output the measurement results; a correlation determination unit which determines a correlation of the plural measurement results; and a measurement number determination unit which determines the number of times of measurement, based on the determination result of the correlation. By executing the program on the computer, the above characteristics measurement device can be realized.

### BRIEF DESCRIPTION OF THE DRAWINGS

FIG. 1 is a block diagram schematically showing a basic configuration for a signal delay time measurement;

FIGS. 2A to 2F are waveforms for explaining a signal delay time measurement method;

FIG. 3 is a block diagram showing an example of an internal configuration of a signal processing circuit;

FIGS. 4A to 4C are waveforms showing examples of a response signal;

FIG. 5 is a flow chart of a signal delay time measurement process;

FIG. 6 is a flow chart of a sound field determination process during the signal delay time process shown in FIG. 5;

FIG. 7 is a flow chart of the sound field determination process during the sound field determination process shown in FIG. 6;

FIG. 8 is a block diagram showing a configuration of an audio system including an automatic sound field correcting system according to an embodiment of the present invention;

FIG. 9 is a block diagram showing an internal configuration of a signal processing circuit shown in FIG. 8;

FIG. 10 is a block diagram showing a configuration of a signal processing unit shown in FIG. 9;

FIG. 11 is a block diagram showing a configuration of a coefficient operation unit shown in FIG. 9;

FIGS. 12A to 12C are block diagrams showing configurations of frequency characteristics correction unit, an inter-channel level correction unit and a delay characteristics correction unit shown in FIG. 11;

FIG. 13 is a diagram showing an example of speaker arrangement in a certain sound field environment;

FIG. 14 is a flow chart showing a main routine of an automatic sound field correction process;

FIG. 15 is a flow chart showing a frequency characteristics correction process;

FIG. 16 is a flow chart showing an inter-channel level correction process; and

FIG. 17 is a flow chart showing a delay correction process.

### BRIEF DESCRIPTION OF THE REFERENCE NUMBER

1 Sound source
2 Signal processing circuit
3 Measurement signal generator
4 D/A converter
6 Speaker
8 Microphone
9 Amplifier
10 A/D converter
251 Differentiating circuit
252 Comparator
253 Background noise measurement unit
254 Threshold determination unit
255 Memory

### DETAILED DESCRIPTION OF THE PREFERRED EMBODIMENTS

The preferred embodiment of the present invention will now be described below with reference to the attached drawings. Hereinafter, a description will be given of such a case that a characteristics measurement technique according to the present invention is applied to the signal delay time measurement in the sound space.

### [Basic Principle]

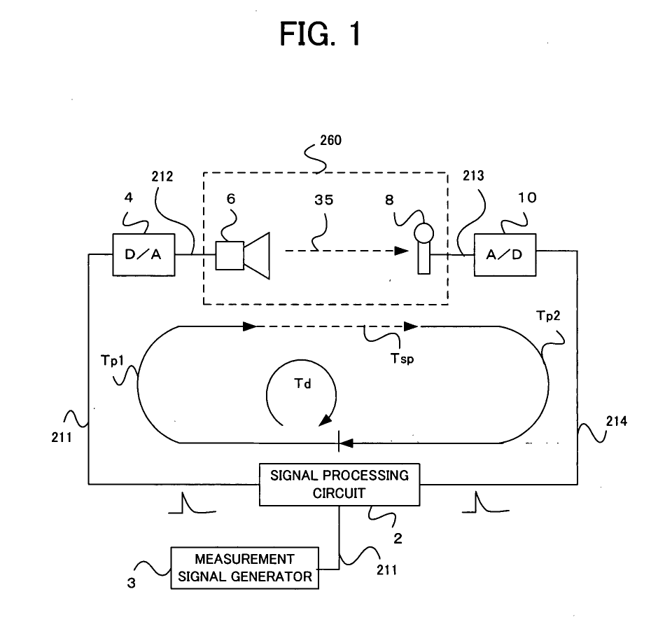

First, the description will be given of a basic principle of a signal delay time measurement according to the present invention. FIG. 1 schematically shows the basic configuration for the signal delay time measurement. As shown in FIG. 1, the signal delay time measurement device includes a signal processing circuit 2, a measurement signal generator 3, a D/A converter 4, a speaker 6, a microphone 8 and an A/D converter 10. The speaker 6 and the microphone 8 are disposed in a sound space 260. It is noted that the sound space 260 may be a listening room, a home theater and the like, for example.

The measurement signal generator 3 generates the pulse signal (hereafter, referred to as “measurement pulse signal”) as a measurement signal 211, and supplies it to the signal processing circuit 2. The measurement pulse signal can be stored in a memory in the measurement signal generator 3 as a digital signal. The signal processing circuit 2 transmits the measurement pulse signal 211 to the D/A converter 4. The D/A converter 4 converts the measurement pulse signal 211 to an analog measurement pulse signal 212, and supplies it to the speaker 6. The speaker 6 outputs a measurement pulse sound 35 corresponding to the measurement pulse signal 212 to the sound space 260 as the measurement signal sound.

The microphone 8 collects the measurement pulse sound 35 in the sound space 260, and transmits it to the A/D converter 10 as an analog response signal 213. The response signal 213 includes a response component of the sound space 260 to the measurement pulse signal 35. The A/D converter 10 converts the response signal 213 to a digital response signal 214, and supplies it to the signal processing circuit 2. The signal processing circuit 2 calculates a signal delay time Td in the sound space 260 by comparing the response signal 214 with a predetermined threshold.

As understood from FIG. 1, the signal delay time Td measured by the signal processing circuit 2 is a sum of a sound delay time Tsp in the sound space and a delay time (mainly, a delay time in the delay time measurement device, and hereafter referred to as “in-device delay time Tp”) other than the sound delay time Tsp. The sound delay time Tsp is a delay time from outputting of the measurement pulse sound 35 from the speaker 6 until receiving of it by the microphone 8 in the sound space 260. Meanwhile, the in-device delay time Tp includes a delay time Tp1 on an output side of the measurement pulse sound and a delay time Tp2 on an input side of the response signal 8. The delay time Tp1 on the output side of the measurement pulse sound includes a time in which the measurement pulse sound 211 is transmitted from the signal processing circuit 2 to the D/A converter 4, and a conversion processing time by the D/A converter 4. In addition, the delay time Tp2 on the input side of the response signal includes a conversion processing time of the response signal collected by the microphone 8 in the A/D converter 10, and a transmission time from the A/D converter 10 to the signal processing circuit 2.

Therefore, even if the sound delay time Tsp is zero (i.e., in a state that the speaker 6 and the microphone 8 are close to each other), since the in-device delay time Tp exists, the signal delay time Td does not become zero. In other words, in a period corresponding to the in-device delay time Tp from the timing at which the signal processing circuit 2 starts outputting the measurement pulse signal 211, the response signal 214 cannot theoretically reach the signal processing circuit 2. Namely, the response signal cannot reach the signal processing circuit 2 in a period (hereafter, referred to as “no-response period”) corresponding to the in-device delay time Tp after the outputting of the measurement pulse signal 211.

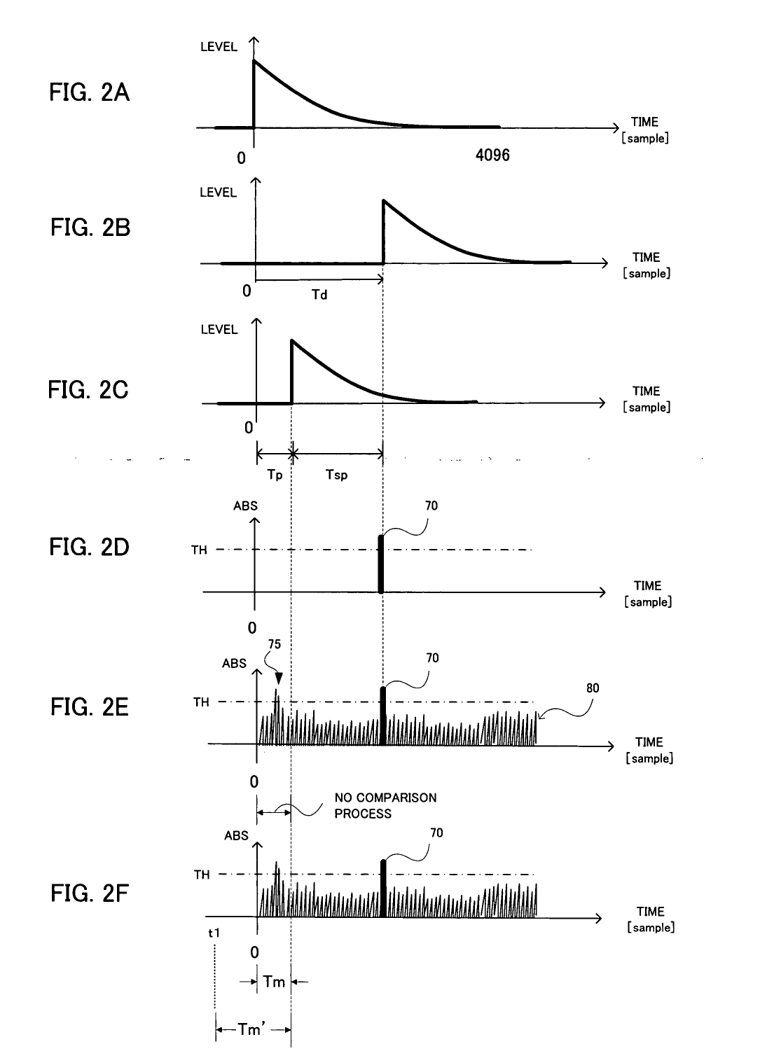

FIGS. 2A to 2C show waveform examples of the response signal 214 received by the signal processing circuit 2. FIG. 2A shows the waveform example of the response signal 214 in a case of assuming that the signal delay time Td is zero. The horizontal axis indicates time, which is indicated by a number of samples, because the response signal 214 is the digital signal. The vertical axis indicates a level of the response signal 214. At time 0, the signal processing circuit 2 outputs the measurement pulse signal 211. By assuming that the signal delay time Td is zero, as shown in FIG. 2A, the response signal 214 shows a waveform exponentially decreasing.

FIG. 2B shows a state of a general sound space, i.e., the response signal waveform in a case that the speaker and the microphone are located apart from each other by several meters in the sound space. The measurement pulse signal is outputted from the signal processing circuit 2 at the time 0. The response signal is inputted to the signal processing circuit 2 with the signal delay time Td.

FIG. 2C shows the response signal waveform in a case that the speaker and the microphone are disposed closely to each other in the sound space. Since the speaker and the microphone are close to each other, the sound delay time Tsp is zero, and the delay time of the response signal corresponds to the in-device delay time Tp. As shown in FIGS. 2B and 2C, the signal delay time Td in the normal state is a sum of the in-device delay time Tp and the sound delay time Tsp. In addition, it is understood that the period of the in-device delay time Tp from the time 0 at which the signal processing circuit 2 outputs the measurement pulse signal is the no-response period in which the response of the measurement pulse sound cannot reach the signal processing circuit 2.

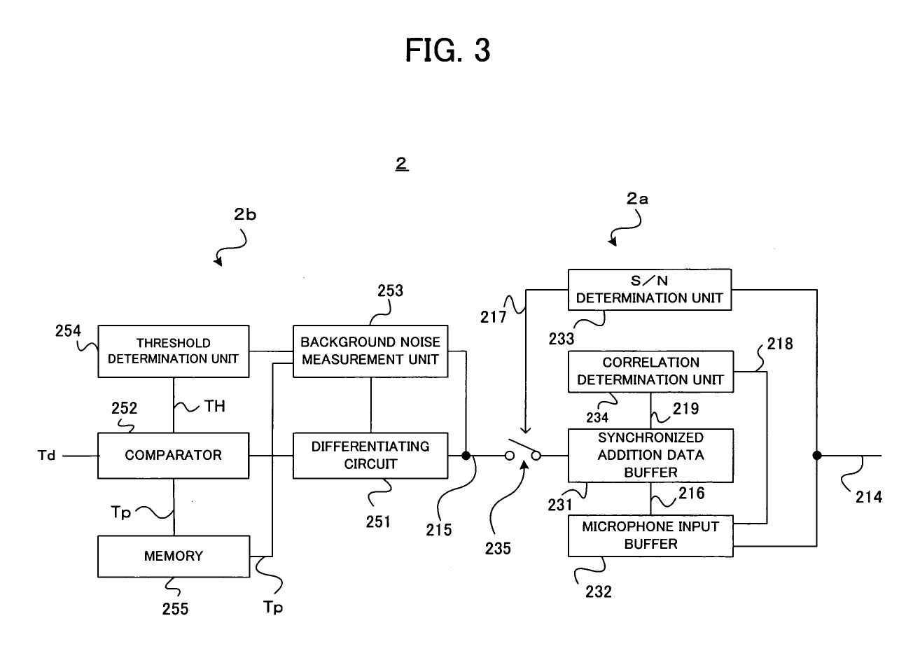

FIG. 3 shows a configuration associated with the time delay measurement in the signal processing circuit 2. The signal processing circuit 2 roughly includes a sound field determination processing unit 2a and a signal delay time measurement unit 2b. The sound field determination processing unit 2a determines the noise state of the sound space prior to the actual delay time measurement, and obtains the measurement data used for the delay time measurement. Specifically, the sound field determination processing unit 2a measures the S/N of the sound space, and determines the number of times of measurement of the measurement data used for the delay time measurement in accordance with the result of the measurement. Then, the sound field determination processing unit 2a obtains the measurement data by the synchronized addition in the determined number of times of measurement. Meanwhile, the signal delay time measurement unit 2b measures the signal delay time of the sound space with using the measurement data obtained by the sound field determination processing unit 2a.

As shown in FIG. 3, the sound field determination processing unit 2a includes a synchronized addition data buffer 231, a microphone input buffer 232, an S/N determination unit 233, a correlation determination unit 234 and a switch 235. The response signal 214 outputted from the A/D converter 10 is supplied to the microphone input buffer 232. The microphone input buffer 232 temporarily stores the response signal 214 obtained in the single measurement executed by outputting the measurement pulse signal, and supplies it to the synchronized addition data buffer 231 as the signal 216. The synchronized addition data buffer 231 executes synchronized addition of the plural response signals 214 obtained by the plural measurements, and stores the result.

“Synchronized addition” means that the plural signals are added with maintaining phase information. If the synchronized addition is executed for the plural times, since the phases are same, the number of signal components included in the response signal 214 increases, e.g., twice in the two measurements, three times in the three measurements, and n times in the n measurements. Meanwhile, though the absolute amount of noise components included in the response signal 214 also increases by the plural measurements, the absolute amount increases by \sqrt{2} times in the two measurements, by \sqrt{3} times in the three measurements, and by \sqrt{n} times in the n measurements. Hence, as the number of synchronized additions increases, the ratio between the increase of the noise component and the increase of the signal component becomes small, and thus the S/N is improved.

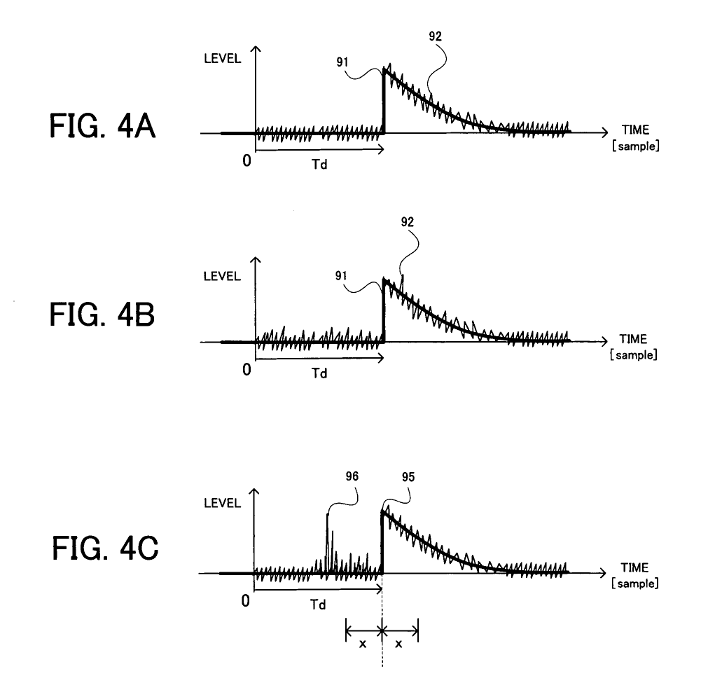

FIGS. 4A and 4B show examples of the response signal 214 obtained by outputting the measurement pulse signal. FIG. 4A shows a waveform of the response signal 214 obtained by the single measurement, and FIG. 4B shows a waveform of the response signal 214 obtained by the other measurement. As shown in FIGS. 4A and 4B, the response signal 214 includes a background noise 92 existing in the sound space. Since the plural measurements are executed by fixing the speaker 6 and the microphone 8 as shown in FIG. 1, the response component 91 (thick line) of the measurement pulse signal included in the response signal 214 has the correlation with the measurement pulse signal, and appears with the same phase for each time. Meanwhile, the background noise 92 (thin line) existing in the sound space basically appears with the different phase for each time, because it has no relation with the measurement pulse signal. In FIGS. 4A and 4B, the response components 91 of the measurement pulse signals have the same phases, but the background noises 92 have the different phases. By the synchronized addition of the plural response signals 214 in the n times, the response components 91 of the measurement pulse signal increases by n times. However, since the background noises 92 have the different phases, the background noises increases by only \sqrt{n} times. Thus, by the synchronized addition of the response signals 214 obtained by the plural measurements, the S/N can be improved by \sqrt{n} times. In theory, when it is prescribed that the response component 91 of the measurement pulse signal has the complete correlation with the measurement pulse signal and the background noise 92 has no correlation with the measurement pulse signal, as the number of synchronized additions becomes larger, the S/N is improved. Concretely, the S/N is improved by 6 dB in the four measurements, by 9 dB in the eight measurements and by 15 dB in the 32 measurements.

The actual synchronized addition process is executed by a method explained below, for example. When the number of synchronized additions is n times, the synchronized addition data buffer 231 stores the 1/n data of the response signal 214 obtained from the microphone input buffer 232 for each time. Hence, when the n measurements are completed, the response signal data after the n synchronized additions is stored in the synchronized addition data buffer 231. The synchronized addition data buffer 231 may add the data itself of the response signal 214 for each time, instead of adding the 1/n response signal data for each time, and may execute the process of calculate 1/n of the added result at the time of completing of the n-th measurement. Then, the synchronized addition data buffer 231 supplies the response signal data after the synchronized addition to the switch 235.

Returning to FIG. 3, the response signal 214 is also supplied to the S/N determination unit 233. The S/N determination unit 233 calculates the S/N of the sound space for each of the plural measurements, and compares it with a desired S/N value. When the calculated S/N becomes larger than the desired S/N value, the S/N determination unit 233 ends the measurement, and closes the switch 235 with using a switch signal 217. Then, the S/N determination unit 233 supplies the response signal data in the synchronized addition data buffer 231 to the signal delay time measurement unit 2b.

The correlation determination unit 234 receives the response signal stored in the microphone input buffer 232 as a signal 218, and receives the response signal stored in the synchronized addition data buffer 231 as a signal 219. Then, the correlation determination unit 234 determines the correlation between the signal 218 and the signal 219. When the correlation is smaller than a predetermined reference, the correlation determination unit 234 increases the number of times of measurement. The correlation determination unit 234 has a function to detect the unexpected noise included in the response signal 214. FIG. 4C shows an example of a wave form of the response signal 214 including the unexpected noise 96. When the level of the normal response signal 214 becomes larger than the predetermined threshold as shown in FIGS. 4A and 4B, it is determined that the waveform 95 shown in FIG. 4C is the response component of the measurement pulse signal. However, as shown in FIG. 4C, when the unexpected noise 96 having the large level exists before the waveform 95, the unexpected noise 96 can be erroneously regarded as the response component of the measurement pulse signal. Therefore, the correlation determination unit 234 determines the correlation between the response signal 214 obtained by each measurement and the response signal obtained in the past, i.e., the response signal stored in the synchronized addition data buffer. When the determined correlation is smaller than the predetermined correlation reference, the correlation determination unit 234 determines that the unexpected noise shown in FIG. 4C occurs, and increases the number of times of measurement. Thereby, it becomes possible to remove the influence of the unexpected noise on the response signal data after the synchronized addition, stored in the synchronized addition data buffer.

As one of the concrete determination methods of the correlation, there is a method of calculating correlation values of the response signals 214 shown in FIGS. 4A to 4C and comparing them with a predetermined reference correlation value. There is another method of detecting a largest value position of the response component 95 of the measurement pulse signal included in the response signal 214 and comparing the position with a largest value position of the response component 95 of the measurement pulse signal included in the response signal obtained in the past. The largest value position of the response component of the measurement pulse signal can be substantially same for each measurement, and can be within the range of at least several samples. Meanwhile, as shown in FIG. 4C, the unexpected noise occurs irrespective of the measurement pulse signal. Therefore, in such a case that the largest value position of the measurement pulse component obtained at this time is detected at a position away from the largest value position of the response component of the measurement pulse signal detected in the past by equal to or larger than a predetermined sample number x, by regarding it as the unexpected noise, a result that the correlation is low may be outputted.

Next, a description will be given of the signal delay measurement unit 2b. The response signal data 215 after the synchronized addition, which is supplied from the synchronized addition data buffer 231 via the switch 235, is inputted into the differentiating circuit 251. The differentiating circuit 251 differentiates the response signal data 215, and calculates the absolute value (ABS) to supply it to the comparator 252.

A background noise measurement unit 253 detects a background noise level from the response signal 214 in a background noise measurement period Tm, which will be described later, and supplies a largest level value thereof to a threshold determination unit 254. The threshold determination unit 254 determines a threshold TH larger than the largest level value of the background noise by a predetermined value, and inputs it to the comparator 252.

A memory 255 stores the in-device delay time Tp, and inputs it to the comparator 252. The comparator 252 compares a differentiating signal of the response signal inputted from the differentiating circuit 251 with the threshold inputted from the threshold determination unit 254, and calculates the signal delay time Td. However, the comparator 252 does not perform the comparison processing of a differentiating value of the response signal and the threshold TH in the no-response period corresponding to the above-mentioned in-device delay time Tp from the timing at which the signal processing circuit 2 starts outputting the measurement signal 211, on the basis of the in-device delay time Tp supplied from the memory 255.

FIGS. 2D to 2F show states of the comparison processing in the comparator 252. FIG. 2D shows a waveform of the differentiating signal of the response signal outputted from the differentiating circuit 251. The horizontal axis indicates time, and the vertical axis indicates a differentiating value (absolute value: ABS). A differentiating waveform 70 appears at a rise-up time of the response signal waveform shown in FIG. 2B.

FIG. 2E is a diagram showing a waveform in which a waveform example of the background noise is added to the waveform diagram of FIG. 2D. As shown in FIG. 2E, if a background noise 80 includes a background noise component 75 larger than the threshold TH, the comparator 252 may erroneously regard it as the response signal 70. However, in the present invention, the in-device delay time Tp is set as the no-response period, as shown in FIG. 2E. Since the pulse 70 corresponding to the response signal cannot arrive in the no-response period, the comparator 252 does not execute the comparison processing. Therefore, even if the background noise component 75 larger than the threshold TH exists in the no-response period, it is avoided to erroneously regard it as the response signal.

Next, the description will be given of a measurement in the background noise measurement unit 253. As described above, the response of the measurement pulse sound cannot arrive during the period corresponding to the in-device delay time Tp from the time 0 at which the signal processing circuit 2 starts outputting the measurement pulse sound, and the response signal can arrive immediately after the period. Thus, since the background noise level immediately before the execution of the comparison processing of the response signal can be obtained in the period, the period can be quite preferred as a period for detecting the background noise level, which is used to determine the threshold TH. The background noise measurement unit 253 measures the background noise level in the period corresponding to the in-device delay time Tp from the time 0, and based on the level, the threshold determination unit 254 determines the threshold TH used by the comparator 252 in the comparison processing immediately after the measurement.

Concretely, as shown in FIG. 3, the background noise measurement unit 253 receives the in-device delay time Tp from the memory 255, and sets the period corresponding to the in-device delay time Tp from the time Oat which the signal processing circuit 2 starts outputting of the measurement pulse sound signal as a background noise measurement period Tm. The background noise measurement unit 253 measures the background noise in the background noise measurement period Tm, and supplies the largest level to the threshold determination unit 254. Thereby, by using the threshold determined based on the background noise level at every time of measuring the signal delay time, it becomes possible to accurately measure the signal delay time.

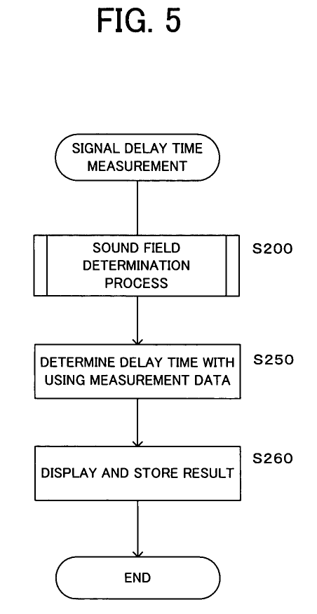

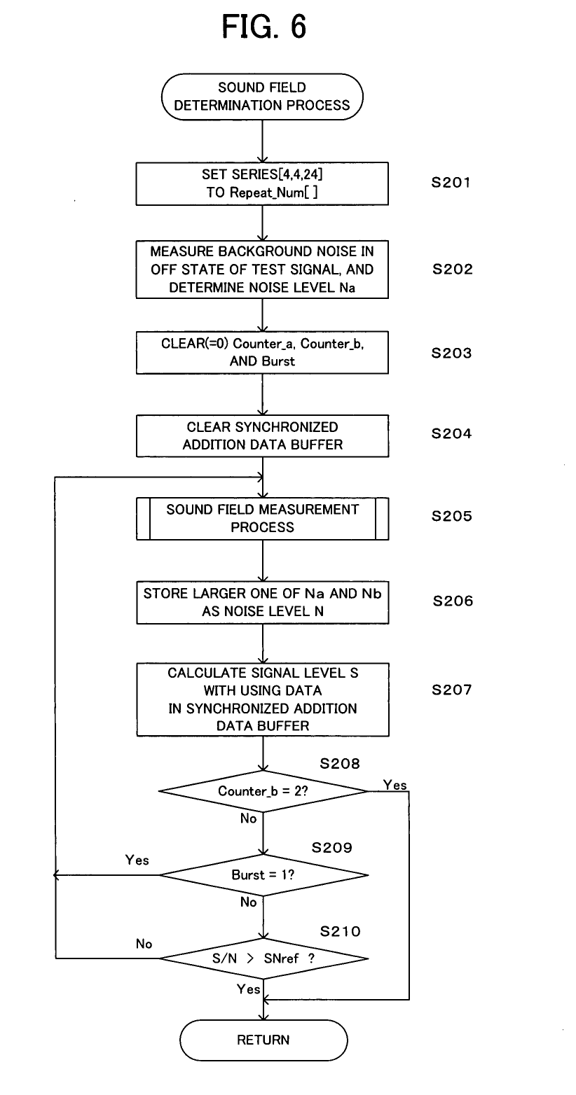

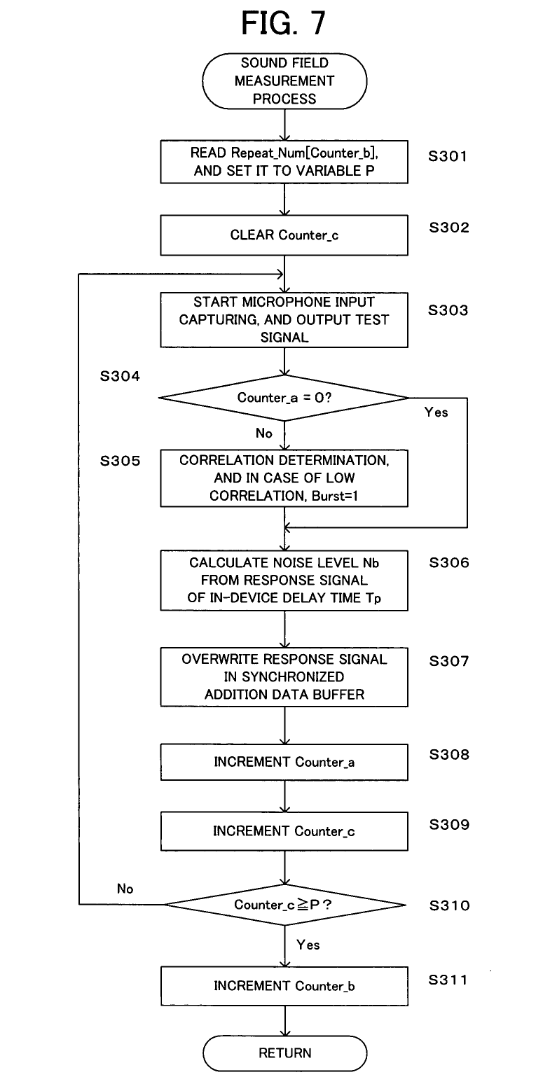

Next, a description will be given of the signal delay time measurement process. FIG. 5 is a flow chart of the signal delay time measurement process. FIG. 6 is a flow chart of the sound field determination process during the signal delay time measurement process shown in FIG. 5, and FIG. 7 is a flow chart of the sound field measurement process during the sound field determination process shown in FIG. 6. Mainly when the signal processing circuit 2 controls the other components, the signal delay time measurement process, which will be explained below, is executed.

As shown in FIG. 5, first, the sound field determination process is executed. In the sound field determination process, first, a series [4,4,24] is set to a function Repeat_Num[ ] (step S201). The function Repeat_Num[ ] is the function for defining the number of times of measurement. As for Repeat_Num[n1,n2,n3], n1 shows the initial set number of times of measurement, and n2 and n3 show the first additional number and the second additional number, respectively. In step S201, the initial set number, the first additional number and the second additional number are set to 4 times, 4 times and 24 times, respectively. Thus, in this embodiment, the sum number of times of measurement maximally becomes 32 times.

Next, in the sound space 260, the background noise is measured by the microphone 8 without outputting the measurement pulse signal (test signal), and the value is prescribed as the noise level Na (step S202). Subsequently, three counters, i.e., Counter_a, Counter_b and Burst, are cleared (i.e., counter value=0) (step S203). The Counter_a shows the total number of times of measurement. The Counter_b shows which measurement of the initial set number, the first additional number and the second additional number the current measurement is included in. Concretely, if Counter_b=0, the current measurement is the measurement during the initial set number. If Counter_b=1, the current measurement is the measurement during the first additional number. If Counter_b=2, the current measurement is the measurement during the second additional set number.

Next, the synchronized addition data buffer 231 is cleared (step S204). Then, the sound field measurement process is executed (step S205).

FIG. 7 shows the sound field measurement process in details. First, the function Repeat_Num[Counter_b] is read and set to a variable P indicating the number of times of measurement (step S301). Thereby, the initial set number “4” is set to the variable P. Next, the Counter_c is cleared, and Counter_c=0 (step S302). The Counter_c shows the current number of the initial set number, the first additional number and the second additional number.

In this manner, the first measurement is executed. Specifically, first, the microphone 8 starts capturing the sound in the sound space 260, and the measurement pulse signal is outputted as the test signal (step S303). Thereby, the response signal by the first measurement is obtained and stored in the microphone input buffer 232.

Next, it is determined whether or not Counter_a=0 (step S304). Since Counter_a=0 in the first measurement, the process goes to step S306. Then, from the response signal stored in the microphone input buffer 232, the noise level Nb in the in-device delay time Tp is calculated (step S306). As described above, the noise level Nb shows the noise level in no-response period in which no response component of the sound space to the measurement pulse signal arrives.

Next, the response signal in the microphone input buffer 232 is supplied to the synchronized addition data buffer 231, and the response data after the synchronized addition is stored (step S307). Then, Counter_a and Counter_c are incremented, respectively (steps S308 and S309).

Next, it is determined whether or not Counter_c becomes equal to or larger than the variable P (step S310). Thereby, it is determined whether or not the measurements of the initial set number (four times in this embodiment) end. In such a case that step S310 is No, the process goes back to step S303, and steps S303 to S310 are repeated. In this manner, when the measurements of the initial set number end (step S310; Yes), Counter_b is incremented (step S311), and the process goes back to the sound field determination process shown in FIG. 6.

When it is determined that the value of Counter_a is not 0 in step S304, i.e., in a case of the second or subsequent measurement, the above-mentioned correlation determination is executed with using the past response signal data (step S305). Then, when it is determined that the correlation between the response signal obtained by this measurement and the past response signal data is smaller than the predetermined reference, “1” is set to a flag Burst. The flag Burst is the flag showing the presence or absence of the above-mentioned unexpected noise. When the unexpected noise is detected, “1” is set to the flag Burst.

Returning to the sound field determination process shown in FIG. 6, the noise levels Na and Nb are compared in step S206, and the larger one is stored as the noise level N. The noise level Na is the noise level measured before starting of the plural sound field measurements, and the noise level Nb is the noise level measured for each time, during the plural sound field measurement. Thus, the S/N is calculated with using the largest noise level N detected in the past. Moreover, the signal level S is calculated with using the response signal data stored in the synchronized addition data buffer 231 (step S207). The signal level S is also used for calculating the S/N.

Next, it is determined whether or not Counter_b=2 (step S208). As described above, Counter_b shows which state of the initial set number, the first additional number and the second additional number the current measurement is included in. “Counter_b=2” means that all of the initial set number, the first additional number and the second additional number are completed. Therefore, when step S208 is Yes, the sound field determination process ends.

Meanwhile, when step S208 is No, it is determined whether or not the flag Burst=1 (step S209). That step S209 is Yes means that the unexpected noise is detected in the past measurement. Thus, in order to remove the influence of the unexpected noise, the process goes back to step S205, and the sound field measurement process is repeated.

When step S209 is No, the S/N is calculated with using the noise level N obtained in step S206 and the signal level S obtained in step S207, and it is determined whether or not the S/N is larger than the smallest value SNref of the desired S/N (step S210). When the S/N is larger than the desired S/N value, since the response signal data obtained by the past measurement satisfies the desired S/N value, the process goes back to the signal delay time measurement shown in FIG. 5 (step S210; Yes). Meanwhile, when the S/N is smaller than the desired S/N value, the process goes back to step S205 in order to further improve the S/N.

In this manner, the sound field measurement process is repeatedly executed until the desired S/N is obtained (step S210; Yes) or until the measurements in all of the initial set number, the first additional number and the second additional number are completed. As a result, the desired S/N is obtained by the effect of the synchronized addition of the response signal data in the plural measurements, or based on the response signal data obtained after execution of the measurements of the maximum number, the subsequent signal delay time measurement is executed. In addition, when the unexpected noise is detected during the measurement, the measurement is further repeated in order to remove the influence. Hence, in any case, it becomes possible to obtain the response signal data with high accuracy in the minimum of time.

When the sound field determination process ends in this manner, the process returns to the signal delay time measurement process shown in FIG. 5. The signal delay time measurement unit 2b determines the delay time by the above-mentioned method with using the measurement data obtained by the sound field determination process, i.e., the response signal data stored in the synchronized addition data buffer 231 (step S250). Then, the result is stored and displayed on a monitor (step S260), and the process ends.

Next, a description will be given of the measurement method of the noise level. In the above embodiment, the noise level Na is measured before the execution of the sound field determination process (step S202, hereinafter also referred to as “pre-measurement”), and the noise level Nb in the in-device delay time Tp is measured in each sound field process (step S306, hereinafter also referred to as “immediate measurement”). The largest value of the noise levels Na and Nb is prescribed as the noise level N, and the S/N is calculated. However, this is not necessary. Namely, only the pre-measurement or the immediate measurement may be employed.

When only the pre-measurement is employed, the processes of steps S206 and S306 may be omitted. When the variation of the noise level N is sufficiently small and it can be regarded that the S/N is not varied, only the pre-measurement may be executed. In this case, there is such advantage that, since the state of the noise is initially defined, the S/N can be obtained by measuring the signal level S only once and the number of times of measurement can be determined at the early stage.

On the other hand, when only the immediate measurement is employed, the processes of steps S202 and S206 may be omitted. As understood from the processes shown in FIG. 6 and FIG. 7, the noise level Nb obtained by the immediate measurement is the noise level obtained based on the measurement data after the synchronized addition obtained by the plural measurements, and is the noise level in such a state that the influence of the noise in the sound space is reduced. Thus, by evaluating the S/N with using the noise level Nb of the pre-measurement and determining the number of times of measurement, the measurement extremely applicable to the noise state in the actual sound space can be executed. In addition, since the immediate measurement is executed at the time closer to the actual characteristics measurement time in comparison with the pre-measurement, the immediate measurement more accurately shows the noise state of the actual characteristics measurement time from that viewpoint, and the measurement more applicable to the noise level of the actual sound space is feasible.

### [Automatic Sound Field Correcting System]

Next, the description will be given of an embodiment of the automatic sound field correcting system to which the present invention is applied, with reference to the attached drawings.

### (I) System Configuration

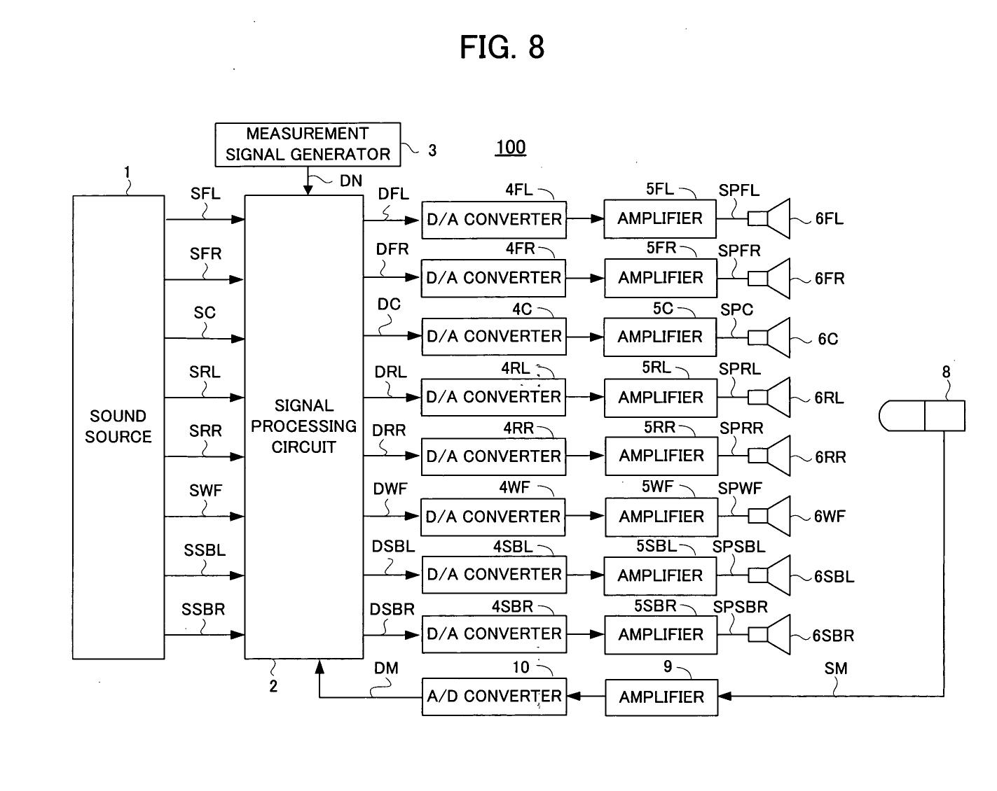

FIG. 8 is a block diagram showing a configuration of an audio system employing the automatic sound field correcting system of the present embodiment.

In FIG. 8, an audio system 100 includes a sound source 1 such as a CD (Compact Disc) player or a DVD (Digital Video Disc or Digital Versatile Disc) player, the signal processing circuit 2 to which the sound source 1 supplies digital audio signals SFL, SFR, SC, SRL, SRR, SWF, SSBL and SSBR via the multi-channel signal transmission paths, and the measurement signal generator 3.

While the audio system 100 includes the multi-channel signal transmission paths, the respective channels are referred to as “FL-channel”, “FR-channel” and the like in the following description. In addition, the subscripts of the reference number are omitted to refer to all of the multiple channels when the signals or components are expressed. On the other hand, the subscript is put to the reference number when a particular channel or component is referred to. For example, the description “digital audio signals S” means the digital audio signals SFL to SSBR, and the description “digital audio signal SFL” means the digital audio signal of only the FL-channel.

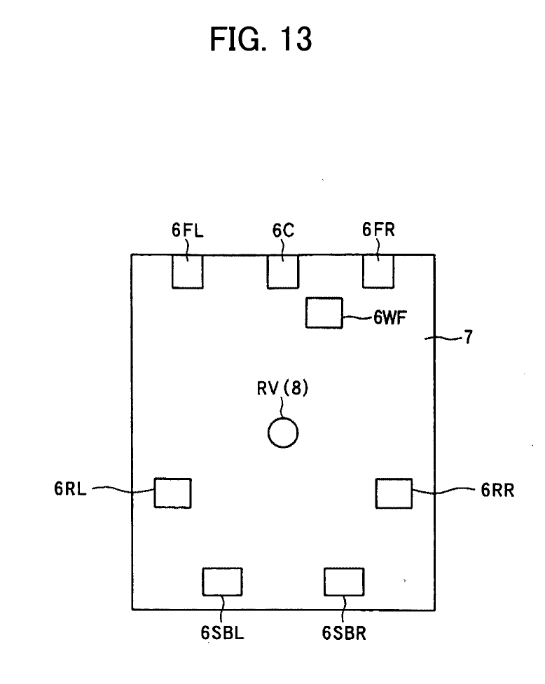

Further, the audio system 100 includes D/A converters 4FL to 4SBR for converting the digital output signals DFL to DSBR of the respective channels processed by the signal processing by the signal processing circuit 2 into analog signals, and amplifiers 5FL to 5SBR for amplifying the respective analog audio signals outputted by the D/A converters 4FL to 4SBR. In this system, the analog audio signals SPFL to SPSBR after the amplification by the amplifiers 5FL to 5SBR are supplied to the multi-channel speakers 6FL to 6SBR positioned in a listening room 7, shown in FIG. 13 as an example, to output sounds.

The audio system 100 also includes a microphone 8 for collecting reproduced sounds at a listening position RV, an amplifier 9 for amplifying a collected sound signal SM outputted from the microphone 8, and an A/D converter 10 for converting the output of the amplifier 9 into a digital collected sound data DM to supply it to the signal processing circuit 2.

The audio system 100 activates full-band type speakers 6FL, 6FR, 6C, 6RL, 6RR having frequency characteristics capable of reproducing sound for substantially all audible frequency bands, a speaker 6WF having frequency characteristics capable of reproducing only low-frequency sounds and surround speakers 6SBL and 6SBR positioned behind the listener, thereby creating sound field with presence around the listener at the listening position RV.

With respect to the positions of the speakers, as shown in FIG. 13, for example, the listener places the two-channel, left and right speakers (a front-left speaker and a front-right speaker) 6FL, 6FR and a center speaker 6C, in front of the listening position RV, in accordance with the listener's taste. Also the listener places the two-channel, left and right speakers (a rear-left speaker and a rear-right speaker) 6RL, 6RR as well as two-channel, left and right surround speakers 6SBL, 6SBR behind the listening position RV, and further places the sub-woofer 6WF exclusively used for the reproduction of low-frequency sound at any position. The automatic sound field correcting system installed in the audio system 100 supplies the analog audio signals SPFL to SPSBR, for which the frequency characteristic, the signal level and the signal propagation delay characteristics for each channel are corrected, to those 8 speakers 6FL to 6SBR to output sounds, thereby creating sound field space with presence.

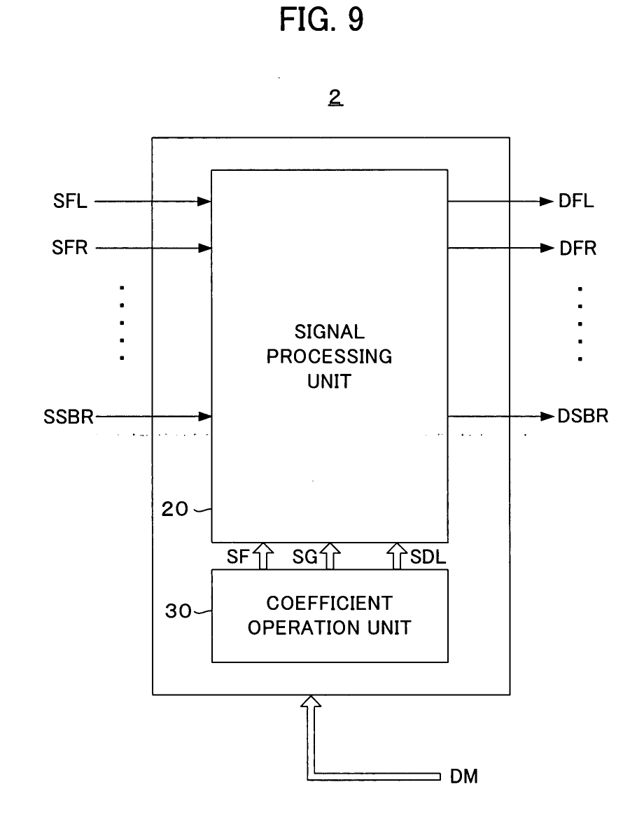

The signal processing circuit 2 may have a digital signal processor (DSP), and roughly includes a signal processing unit 20 and a coefficient operation unit 30 as shown in FIG. 9. The signal processing unit 20 receives the multi-channel digital audio signals from the sound source 1 reproducing sound from various sound sources such as a CD, a DVD or else, and performs the frequency characteristics correction, the level correction and the delay characteristics correction for each channel to output the digital output signals DFL to DSBR.

The coefficient operation unit 30 receives the signal collected by the microphone 8 as the digital collected sound data DM, generates the coefficient signals SF1 to SF8, SG1 to SG8, SDL1 to SDL8 for the frequency characteristics correction, the level correction and the delay characteristics correction, and supplies them to the signal processing unit 20. The signal processing unit 20 appropriately performs the frequency characteristics correction, the level correction and the delay characteristics correction based on the collected sound data DM from the microphone 8, and the speakers 6 output optimum sounds.

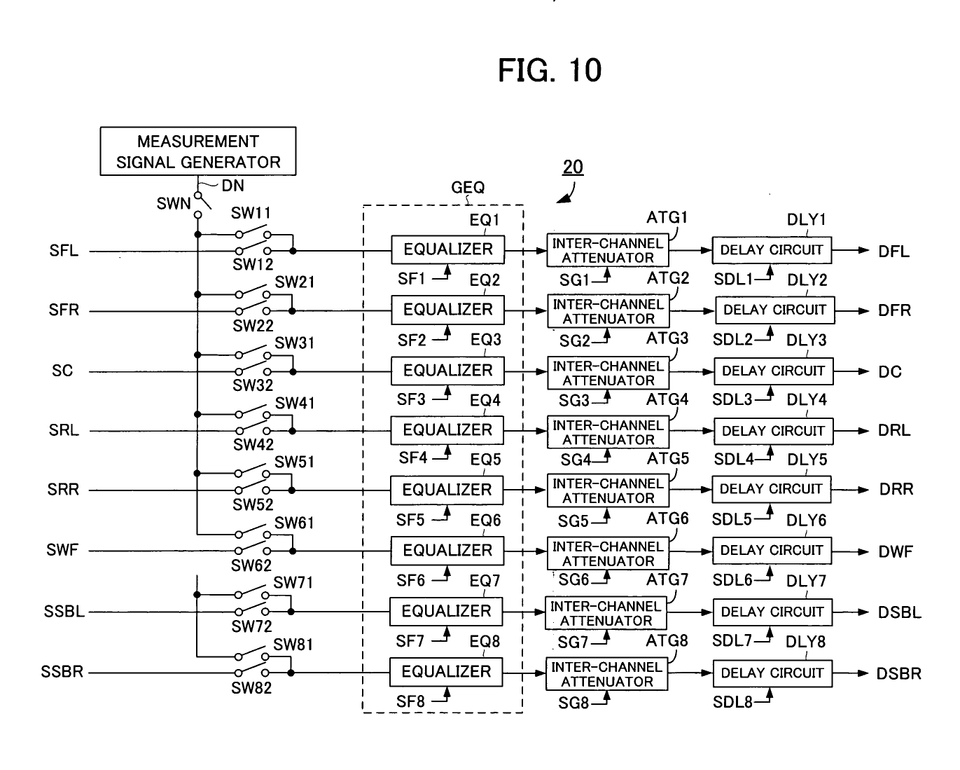

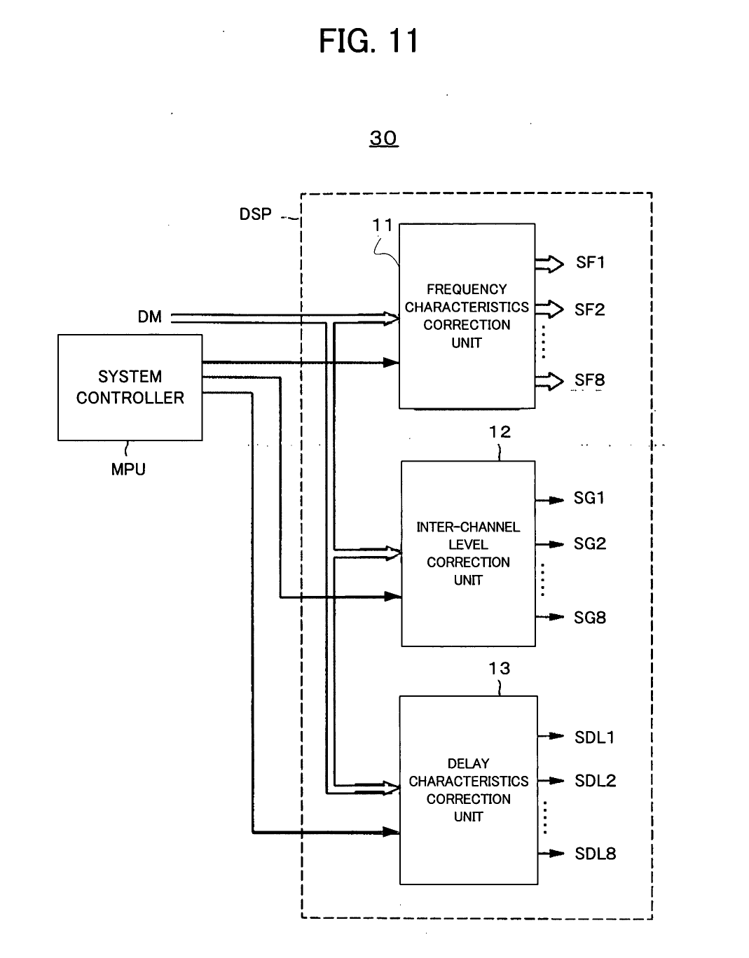

As shown in FIG. 10, the signal processing unit 20 includes a graphic equalizer GEQ, inter-channel attenuators ATG1 to ATG8, and delay circuits DLY1 to DLY8. On the other hand, the coefficient operation unit 30 includes, as shown in FIG. 11, a system controller MPU, frequency characteristics correction unit 11, an inter-channel level correction unit 12 and a delay characteristics correction unit 13. The frequency characteristics correction unit 11, the inter-channel level correction unit 12 and the delay characteristics correction unit 13 constitute DSP.

The frequency characteristics correction unit 11 adjusts the frequency characteristics of the equalizers EQ1 to EQ8 corresponding to the respective channels of the graphic equalizer GEQ. The inter-channel level correction unit 12 controls the attenuation factors of the inter-channel attenuators ATG1 to ATG8, and the delay characteristics correction unit 13 controls the delay times of the delay circuits DLY1 to DLY8. Thus, the sound field is appropriately corrected.

The equalizers EQ1 to EQ5, EQ7 and EQ8 of the respective channels are configured to perform the frequency characteristics correction for each frequency band. Namely, the audio frequency band is divided into 9 frequency bands (each of the center frequencies are f1 to f9), for example, and the coefficient of the equalizer EQ is determined for each frequency band to correct frequency characteristics. It is noted that the equalizer EQ6 is configured to control the frequency characteristics of low-frequency band.

The audio system 100 has two operation modes, i.e., an automatic sound field correcting mode and a sound source signal reproducing mode. The automatic sound field correcting mode is an adjustment mode, performed prior to the signal reproduction from the sound source 1, wherein the automatic sound field correction is performed for the environment that the audio system 100 is placed. Thereafter, the sound signal from the sound source 1 such as a CD player is reproduced in the sound source signal reproduction mode. An explanation below mainly relates to the correction operation in the automatic sound field correcting mode.

With reference to FIG. 10, the switch element SW12 for switching ON and OFF the input digital audio signal SFL from the sound source 1 and the switch element SW11 for switching ON and OFF the input measurement signal DN from the measurement signal generator 3 are connected to the equalizer EQ1 of the FL-channel, and the switch element SW11 is connected to the measurement signal generator 3 via the switch element SWN.

The switch elements SW11, SW12 and SWN are controlled by the system controller MPU configured by microprocessor shown in FIG. 11. When the sound source signal is reproduced, the switch element SW12 is turned ON, and the switch elements SW11 and SWN are turned OFF. On the other hand, when the sound field is corrected, the switch element SW12 is turned OFF and the switch elements SW11 and SWN are turned ON.

The inter-channel attenuator ATG1 is connected to the output terminal of the equalizer EQ1, and the delay circuit DLY1 is connected to the output terminal of the inter-channel attenuator ATG1. The output DFL of the delay circuit DLY1 is supplied to the D/A converter 4FL shown in FIG. 8.

The other channels are configured in the same manner, and switch elements SW21 to SW81 corresponding to the switch element SW11 and the switch elements SW22 to SW82 corresponding to the switch element SW12 are provided. In addition, the equalizers EQ2 to EQ8, the inter-channel attenuators ATG2 to ATG8 and the delay circuits DLY2 to DLY8 are provided, and the outputs DFR to DSBR from the delay circuits DLY2 to DLY8 are supplied to the D/A converters 4FR to 4SBR, respectively, shown in FIG. 8.

Further, the inter-channel attenuators ATG1 to ATG8 vary the attenuation factors within the range equal to or smaller than 0 dB in accordance with the adjustment signals SG1 to SG8 supplied from the inter-channel level correction unit 12. The delay circuits DLY1 to DLY8 control the delay times of the input signal in accordance with the adjustment signals SDL1 to SDL8 from the phase characteristics correction unit 13.

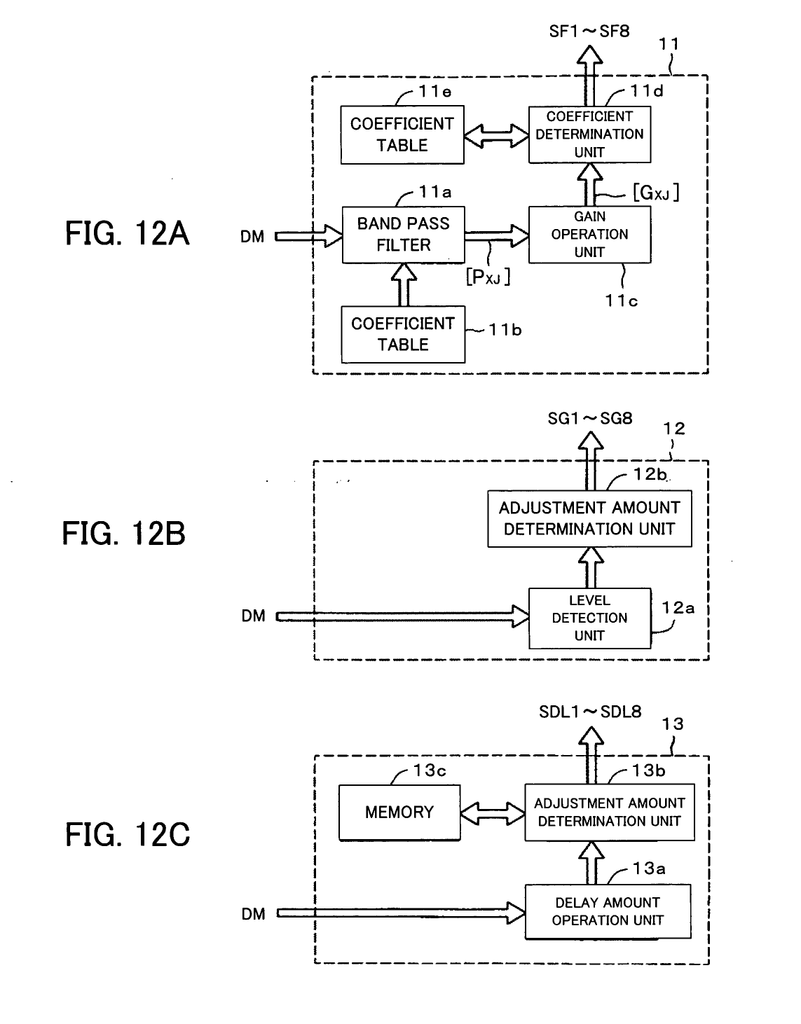

The frequency characteristics correction unit 11 has a function to adjust the frequency characteristics of each channel to have a desired characteristic. As shown in FIG. 12A, the frequency characteristics correction unit 11 includes a band-pass filter 11a, a coefficient table 11b, a gain operation unit 11c, a coefficient determination unit 11d and a coefficient table 11e.

The band-pass filter 11a is configured by a plurality of narrow-band digital filters passing 9 frequency bands set to the equalizers EQ1 to EQ8. The band-pass filter 11a discriminates 9 frequency bands each including center frequency f1 to f9 from the collected sound data DM from the A/D converter 10, and supplies the data [PxJ] indicating the level of each frequency band to the gain operation unit 11c. The frequency discriminating characteristics of the band-pass filter 11a is determined based on the filter coefficient data stored, in advance, in the coefficient table 11b.

The gain operation unit 11c operates the gains of the equalizers EQ1 to EQ8 for the respective frequency bands at the time of the automatic sound field correction based on the data [PxJ] indicating the level of each frequency band, and supplies the gain data [GxJ] thus operated to the coefficient determination unit 11d. Namely, the gain operation unit 11c applies the data [PxJ] to the transfer functions of the equalizers EQ1 to EQ8 known in advance to calculate the gains of the equalizers EQ1 to EQ8 for the respective frequency bands in the reverse manner.

The coefficient determination unit 11d generates the filter coefficient adjustment signals SF1 to SF8, used to adjust the frequency characteristics of the equalizers EQ1 to EQ8, under the control of the system controller MPU shown in FIG. 11. It is noted that the coefficient determination unit 11d is configured to generate the filter coefficient adjustment signals SF1 to SF8 in accordance with the conditions instructed by the listener, at the time of the sound field correction. In a case where the listener does not instruct the sound field correction condition and the normal sound field correction condition preset in the sound field correcting system is used, the coefficient determination unit 11d reads out the filter coefficient data, used to adjust the frequency characteristics of the equalizers EQ1 to EQ8, from the coefficient table 11e by using the gain data [GxJ] for the respective frequency bands supplied from the gain operation unit 11c, and adjusts the frequency characteristics of the equalizers EQ1 to EQ8 based on the filter coefficient adjustment signals SF1 to SF8 of the filter coefficient data.

In other words, the coefficient table 11e stores the filter coefficient data for adjusting the frequency characteristics of the equalizers EQ1 to EQ8, in advance, in a form of a look-up table. The coefficient determination unit 11d reads out the filter coefficient data corresponding to the gain data [GxJ], and supplies the filter coefficient data thus read out to the respective equalizers EQ1 to EQ8 as the filter coefficient adjustment signals SF1 to SF8. Thus, the frequency characteristics are controlled for the respective channels.

Next, the description will be given of the inter-channel level correction unit 12. The inter-channel level correction unit 12 has a role to adjust the sound pressure levels of the sound signals of the respective channels to be equal. Specifically, the inter-channel level correction unit 12 receives the collected sound data DM obtained when the respective speakers 6FL to 6SBR are individually activated by the measurement signal (pink noise) DN outputted from the measurement signal generator 3, and measures the levels of the reproduced sounds from the respective speakers at the listening position RV based on the collected sound data DM.

FIG. 12B schematically shows the configuration of the inter-channel level correction unit 12. The collected sound data DM outputted by the A/D converter 10 is supplied to a level detection unit 12a. It is noted that the inter-channel level correction unit 12 uniformly attenuates the signal levels of the respective channels for all frequency bands, and hence the frequency band division is not necessary. Therefore, the inter-channel level correction unit 12 does not include any band-pass filter as shown in the frequency characteristics correction unit 11 in FIG. 12A.

The level detection unit 12a detects the level of the collected sound data DM, and carries out gain control so that the output audio signal levels for all channels become equal to each other. Specifically, the level detection unit 12a generates the level adjustment amount indicating the difference between the level of the collected sound data thus detected and a reference level, and supplies it to an adjustment amount determination unit 12b. The adjustment amount determination unit 12b generates the gain adjustment signals SG1 to SG8 corresponding to the level adjustment amount received from the level detection unit 12a, and supplies the gain adjustment signals SG1 to SG8 to the respective inter-channel attenuators ATG1 to ATG8. The inter-channel attenuators ATG1 to ATG8 adjust the attenuation factors of the audio signals of the respective channels in accordance with the gain adjustment signals SG1 to SG8. By adjusting the attenuation factors of the inter-channel level correction unit 12, the level adjustment (gain adjustment) for the respective channels is performed so that the output audio signal level of the respective channels become equal to each other.

The delay characteristics correction unit 13 adjusts the signal delay resulting from the difference in distance between the positions of the respective speakers and the listening position RV. Namely, the delay characteristics correction unit 13 has a role to prevent that the output signals from the speakers 6 to be listened simultaneously by the listener reach the listening position RV at different times. Therefore, the delay characteristics correction unit 13 measures the delay characteristics of the respective channels based on the collected sound data DM which is obtained when the speakers 6 are individually activated by the measurement signal DN outputted from the measurement signal generator 3, and corrects the phase characteristics of the sound field space based on the measurement result.

Specifically, by turning over the switches SW11 to SW82 shown in FIG. 10 one after another, the measurement signal DN generated by the measurement signal generator 3 is output from the speakers 6 for each channel, and the output sound is collected by the microphone 8 to generate the correspondent collected sound data DM. Assuming that the measurement signal is a pulse signal such as an impulse, the difference between the time when the speaker 6 outputs the pulse measurement signal and the time when the microphone 8 receives the correspondent pulse signal is proportional to the distance between the speaker 6 of each channel and the listening position RV. Therefore, the difference in distance of the speakers 6 of the respective channels and the listening position RV may be absorbed by setting the delay time of all channels to the delay time of the channel having largest delay time. Thus, the delay time between the signals generated by the speakers 6 of the respective channels become equal to each other, and the sound outputted from the multiple speakers 6 and coincident with each other on the time axis simultaneously reach the listening position RV.

FIG. 12C shows the configuration of the delay characteristics correction unit 13. A delay amount operation unit 13a receives the collected sound data DM, and operates the signal delay amount (time) resulting from the sound field environment for the respective channels on the basis of the pulse delay amount between the pulse measurement signal and the collected sound data DM. A delay amount determination unit 13b receives the signal delay amounts for the respective channels from the delay amount operation unit 13a, and temporarily stores them in a memory 13c. When the signal delay amounts for all channels are operated and temporarily stored in the memory 13c, the delay amount determination unit 13b determines the adjustment amounts of the respective channels such that the reproduced signal of the channel having the largest signal delay amount reaches the listening position RV simultaneously with the reproduced sounds of other channels, and supplies the adjustment signals SDL1 to SDL8 to the delay circuits DLY1 to DLY8 of the respective channels. The delay circuits DLY1 to DLY8 adjust the delay amount in accordance with the adjustment signals SDL1 to SDL8, respectively. Thus, the delay characteristics for the respective channels are adjusted. It is noted that, while the above example assumed that the measurement signal for adjusting the delay time is the pulse signal, this invention is not limited to this, and other measurement signal may be used.

In the present invention, the delay amount operation unit 13a includes each component shown in FIG. 3. The background noise measurement unit 253 measures the largest level of the background noise in the background noise measurement period Tm including the in-device delay time Tp, and the threshold determination unit 254 determines the threshold TH based on the largest level. The differentiating circuit 251 differentiates a reproduction signal of each channel to calculate the absolute value. The comparator 252 does not execute the comparison processing in the no-response period, i.e., in the period until the passing of the in-device delay time Tp from the output time of the measurement signal, and compares the absolute value of the reproduction signal with the threshold TH after the passing of the no-response period to determine the signal delay amount Tp. This process is executed for each channel.

### (II) Automatic Sound Field Correction

Next, the description will be given of the operation of the automatic sound field correction by the automatic sound field correcting system employing the configuration described above.

First, as the environment in which the audio system 100 is used, the listener positions the multiple speakers 6FL to 6SBR in a listening room 7 as shown in FIG. 13, and connects the speakers 6FL to 6SBR to the audio system 100 as shown in FIG. 8. When the listener manipulates a remote controller (not shown) of the audio system 100 to instruct the start of the automatic sound field correction, the system controller MPU executes the automatic sound field correction process in response to the instruction.

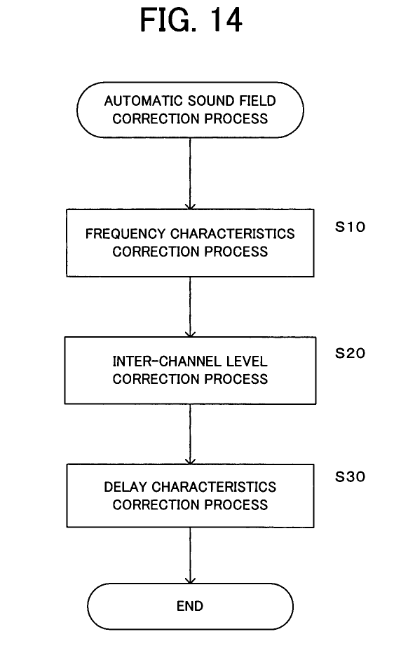

Next, the basic principle of the automatic sound field correction according to the present invention will be described. As described above, the processes executed in the automatic sound field correction are the frequency characteristics correction of each channel, the correction of the sound pressure level and the delay characteristics correction. The description will schematically be given of the automatic sound field correction process with reference to a flow chart shown in FIG. 14.

First, in step S10, the frequency characteristics correction unit 11 adjusts the frequency characteristics of the equalizers EQ1 to EQ8. Next, in an inter-channel level correction process in step S20, the inter-channel level correction unit 12 adjusts the attenuation factors of the inter-channel attenuators ATG 1 to ATG 8 provided for the respective channels. Next, in a delay characteristics correction process in step S30, the delay characteristics correction unit 13 adjusts the delay time of the delay circuits DLY1 to DLY8 of all the channels. The automatic sound field correction according to the present invention is performed in this order.

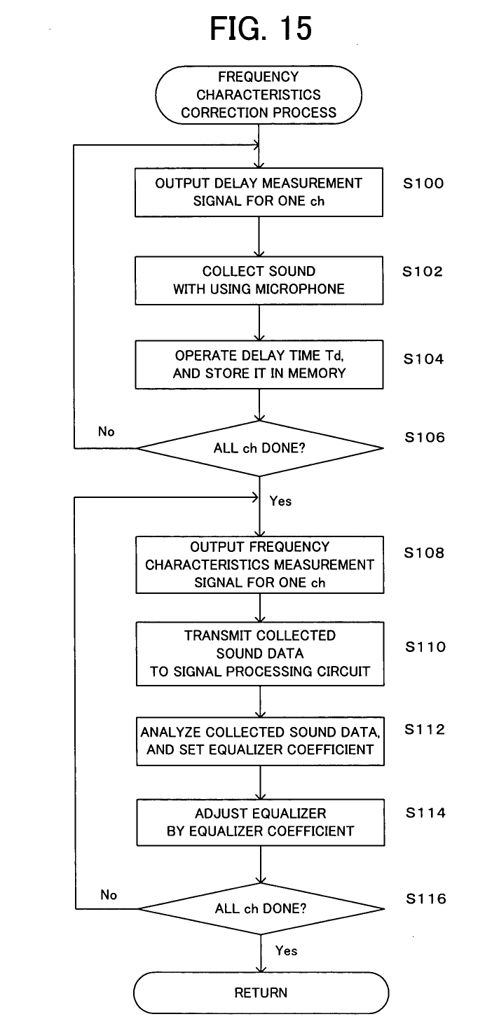

Next, the operation for each process will be explained in order. First, the frequency characteristics correction process in step S10 will be explained with reference to FIG. 15. FIG. 15 is a flow chart of the frequency characteristics correction process according to the present embodiment. It is noted that the frequency characteristics correction process shown in FIG. 15 performs the delay measurement for each channel prior to the frequency characteristics correction process for each channel. The delay measurement is the process of preliminarily measuring a delay time Td from the output of the measurement signal by the signal processing circuit 2 until arrival of the correspondent collected sound data at the signal processing circuit 2 for each channel. In FIG. 15, a procedure in steps S100 to S106 corresponds to the delay measurement process, and a procedure in steps S108 to S115 corresponds to an actual frequency characteristics correction process.

In FIG. 15, the signal processing circuit 2 outputs the pulse delay measurement signal in one of the plural channels at first, and the signal is outputted from the speaker 6 as the measurement signal sound (step S100). The measurement signal sound is collected by the microphone 8, and the collected sound data DM is supplied to the signal processing circuit 2 (step S102). The frequency characteristics correction unit 11 in the signal processing circuit 2 operates the delay time Td, and stores it in its memory and the like (step S104). When all the processes of steps S100 to S104 are executed with respect to all the channels (step S106; Yes), the delay times Td of all the channels are stored in the memory. Thus, the delay time measurement is completed.

Next, the frequency characteristics correction is executed for each channel. Namely, the signal processing circuit 2 outputs the frequency characteristics measurement signal such as the pink noise for one channel, and the signal is outputted from the speaker 6 as the measurement signal sound (step S108). The measurement signal sound is collected by the microphone 8, and the collected sound data is obtained in the frequency characteristics correction unit 11 in the signal processing circuit 2 (step S110). The gain operation unit 11c in the frequency characteristics correction unit 11 analyzes the collected sound data, and the coefficient determination unit 11d sets the equalizer coefficient (step S112). On the basis of the equalizer coefficient, the equalizer is adjusted (step S114). Thereby, based on the collected sound data, the frequency characteristics correction is completed for one channel. The process is executed for all the channels (step S116; Yes), and the frequency characteristics correction process is completed.

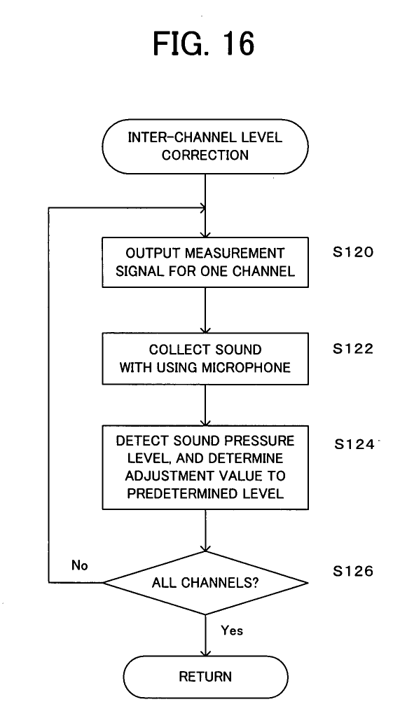

Next, an inter-channel level correction process in step S20 is performed. The inter-channel level correction process is performed in accordance with the flow chart shown in FIG. 16. In the inter-channel level correction process, the correction is performed by maintaining a state in which the frequency characteristics of the graphic equalizer GEQ set by the previous frequency characteristics correction process is adjusted by the above-mentioned frequency characteristics correction process.

In the signal processing unit 20 shown in FIG. 10, by making the switch SW11 in the ON state and the switch SW12 in the OFF state in the first place, the measurement signal DN (pink noise) is supplied to the one channel (e.g., FL channel), and the measurement signal DN is outputted from the speaker 6FL (step S120). The microphone 8 collects the signal, and the collected sound data DM is supplied to the inter-channel level correction unit 12 in the coefficient operation unit 30 via the amplifier 9 and the A/D converter 10 (step S122). In the inter-channel level correction unit 12, the level detection unit 12a detects the sound pressure level of the collected sound data DM, and transmits it to the adjustment amount determination unit 12b. The adjustment amount determination unit 12b generates the adjusting signal SG1 of the inter-channel attenuator ATG1 so that the detected sound pressure level corresponds to the predetermined sound pressure level which is set to a target level table in advance, and supplies the adjusting signal SG1 to the inter-channel attenuator ATG1 (step S124). In that way, the correction is performed so that the sound pressure level of the one channel corresponds to the predetermined sound pressure level. The process is executed for each channel in order, and when the level correction is completed for all the channels (step S126; Yes), the process returns to the main routine in FIG. 14.

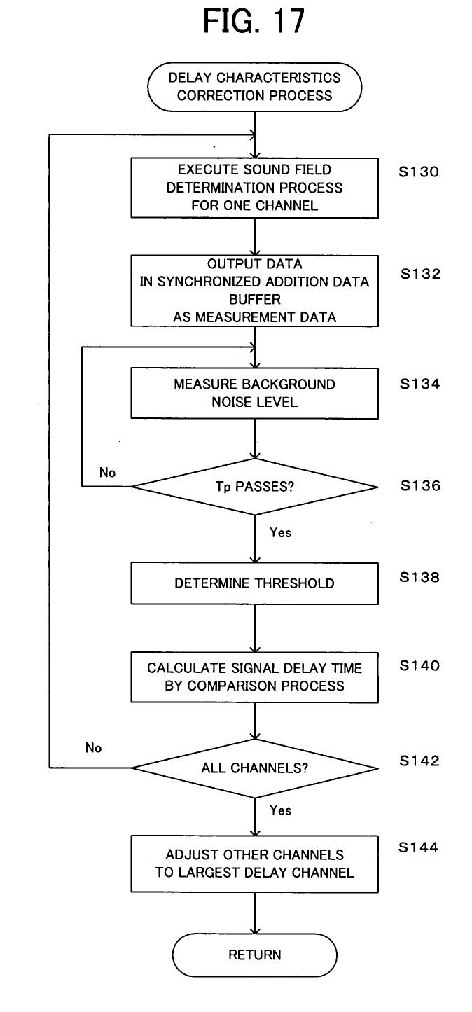

Next, the delay characteristics correction process in step S30 is executed in accordance with a flow chart shown in FIG. 17. First, by making the switch SW11 in the ON state and the switch SW12 in the OFF state for the one channel (e.g., FL channel), the measurement signal DN is outputted from the speaker 6 (step S130). Next, the outputted measurement signal DN is collected by the microphone 8, and the collected sound data DM is inputted to the delay characteristics correction unit 13 in the coefficient operation unit 30 (step S132).

As described above, the delay amount operation unit 13a includes each component shown in FIG. 3. In the delay amount operation unit 13a, the data in the synchronized addition data buffer 231 is used as the measurement data (step S132), and the background noise measurement unit 253 measures the background noise level (step S134). The measurement is performed until the background noise measurement period Tm ends, i.e., during the period of the predetermined in-device delay time Tp from the output time of the measurement pulse signal. The time period is also set to the no-response time, and the comparison processing by the comparator 252 is not executed during the period.

When the in-device delay time Tp passes (step S136; Yes), the no-response period ends. Therefore, the threshold determination unit 254 determines the threshold (step S138). The comparator 252 executes the comparison processing and calculates the signal delay amount Td (step S140).

The process is executed for all the other channels. When the process is completed for all the channels (step S142; Yes), the memory 13c stores the delay amount of all the channels. Next, based on storage contents of the memory 13c, the coefficient operation unit 13b determines the coefficients of the delay circuits DLY1 to DLY8 of the respective channels so that the signals of all the other channels simultaneously reach the listening position RV with respect to the channel having the largest delay amount in all the channels, and supplies them to the respective delay circuits DLYs (step S138). Thereby, the delay characteristics correction is completed.

In that way, the frequency characteristic, the inter-channel level and the delay characteristics are corrected, and the automatic sound field correction is completed.

### [Modification]

In the above-mentioned embodiment, the signal process according to the present invention is realized by the signal processing circuit. Instead, if the identical signal process is designed as a program to be executed on a computer, the signal process can be realized on the computer. In that case, the program is supplied by a recording medium, such as a CD-ROM and a DVD, or by communication by using a network and the like. As the computer, a personal computer and the like can be used, and an audio interface corresponding to plural channels, plural speakers and microphones and the like are connected to the computer as peripheral devices. By executing the above-mentioned program on the personal computer, the measurement signal is generated by using the sound source provided inside or outside the personal computer, and is outputted via the audio interface and the speaker to be collected by using the microphone. Thereby, the above-mentioned sound characteristics measuring device and automatic sound field correcting device can be realized by using the computer.

Additionally, in the above embodiment, the characteristics measurement device according to the present invention is applied to the automatic sound field correction device for measuring the sound field characteristics. However, the characteristics measurement device according to the present invention is applicable to various kinds of characteristics measurements. For example, the characteristics measurement device is applicable to general distance measurements such as a light transmission characteristics, a wave transmission characteristics, an electric circuit characteristics and an inter-vehicular distance in a certain environment. As for the sound characteristics, the characteristics measurement device is applicable to a distance measurement, a level measurement, a frequency characteristics measurement, a standing wave measurement, a speaker large/small determination measurement and a speaker existence/absence determination measurement. Namely, the characteristics measurement device of the present invention is applicable to various kinds of measurement devices for measuring characteristics subjected to the measurement by outputting the test signal and measuring the response.

### INDUSTRIAL APPLICABILITY

The present invention is applicable to a sound field control system used in an environment for reproducing sounds with using plural speakers.

1-12. (canceled)

13. A characteristics measurement device which measures characteristics subjected to a measurement, comprising:
a noise level measurement unit which measures a noise level in an environment subjected to the measurement;
a noise state determination unit which determines a noise state in the environment, based on the noise level;
a measurement number determination unit which determines a number of times of measurement, based on the noise state; and
a characteristics measurement unit which measures the characteristics subjected to the measurement for the number of times of measurement, and executes synchronized addition of measurement results to output the measurement results,
wherein the noise level measurement unit measures the noise level prior to the measurement of the characteristics subjected to the measurement, and measures the noise level during the measurement of the characteristics subjected to the measurement,
wherein the noise state determination unit_determines the noise state, based on a largest noise level which is measured.

14. The characteristics measurement device according to claim 1, further comprising a signal level measurement unit which measures the signal level subjected to the measurement in the environment,
wherein the noise state determination unit determines the noise state, based on the signal level and the noise level.

15. The characteristics measurement device according to claim 13,
wherein the noise level measurement unit measures the noise level prior to the measurement of the characteristics subjected to the measurement.

16. The characteristics measurement device according to claim 13,
wherein the noise level measurement unit measures the noise level during the measurement of the characteristics subjected to the measurement.

17. The characteristics measurement device according to claim 13,
wherein, as the noise state becomes insufficient, the measurement number determination unit increases the number of times of measurement.

18. A characteristics measurement device which measures characteristics subjected to a measurement, comprising:
a noise level measurement unit which measures a noise level in an environment subjected to the measurement;
a noise state determination unit which determines a noise state in the environment, based on the noise level;
a measurement number determination unit which determines a number of times of measurement, based on the noise state;
a characteristics measurement unit which measures the characteristics subjected to the measurement for the number of times of measurement, and executes synchronized addition of measurement results to output the measurement results; and
a correlation determination unit which determines a correlation of the plural measurement results,
wherein the measurement number determination unit increases the number of times of measurement, when the correlation is smaller than a predetermined reference.

19. A characteristics measurement device which measures characteristics subjected to a measurement, comprising:
a characteristics measurement unit which measures the characteristics subjected to the measurement for a number of plural measurements and executes synchronized addition of measurement results to output the measurement results;
a correlation determination unit which determines a correlation of the plural measurement results; and
a measurement number determination unit which determines the number of times of measurement, based on a determination result of the correlation.

20. The characteristics measurement device according to claim 13, wherein the characteristic subjected to the measurement is any one of a sound characteristic, a light transmission characteristic, a wave transmission characteristic and an electric circuit characteristic.

21. The characteristics measurement device according to claim 20, wherein the sound characteristic is any one of a signal delay characteristic, a sound pressure level characteristic, a frequency characteristic and a speaker characteristic in a sound space.

22. A computer program product in a computer-readable medium executed by a characteristics measurement device to measure characteristics subjected to a measurement, the characteristics measurement device making a computer function as:
a noise level measurement unit which measures a noise level in an environment subjected to a measurement;
a noise state determination unit which determines a noise state in the environment, based on the noise level;
a measurement number determination unit which determines a number of times of measurement, based on the noise state; and
a characteristics measurement unit which measures the characteristics subjected to the measurement for the number of times of measurement, and executes synchronized addition of measurement results to output the measurement results,
wherein the noise level measurement unit measures the noise level prior to the measurement of the characteristics subjected to the measurement, and measures the noise level during the measurement of the characteristics subjected to the measurement,
wherein the noise state determination unit determines the noise state, based on a largest noise level which is measured.

23. A computer program product in a computer-readable medium executed by a characteristics measurement device to measure characteristics subjected to a measurement, the characteristics measurement device making a computer function as:
a characteristics measurement unit which measures characteristics subjected to the measurement for a number of plural measurements, and executes synchronized addition of measurement results to output the measurement results;
a correlation determination unit which determines a correlation of the plural measurement results; and
a measurement number determination unit which determines the number of times of measurement, based on the determination result of the correlation.
